(19) United States
(12) Patent Application Publication
(10) Pub. No.: US 2021/0012778 A1
(43) Pub. Date: Jan. 14, 2021

(54) INFORMATION PROCESSING DEVICE AND INFORMATION PROCESSING SYSTEM

(71) Applicant: SONY CORPORATION, TOKYO (JP)

(72) Inventor: HIROAKI OGAWA, CHIBA (JP)

(21) Appl. No.: 16/979,973

(22) PCT Filed: Jan. 30, 2019
(86) PCT No.: PCT/JP2019/003141

§ 371 Date: Sep. 11, 2020

(30) Foreign Application Priority Data
Mar. 20, 2018 (JP) 2018-052264

(51) Int. Cl. G10L 15/32; G10L 15/18; G06K 9/00; G10L 15/25; G10L 15/30; G10L 15/22

(52) U.S. Cl. CPC G10L 15/32; G10L 15/1807; G06K 9/00302; G10L 13/02; G10L 15/30; G10L 15/22; G10L 15/25

(57) ABSTRACT

An information processing device according to the present disclosure includes an information extractor and a judging unit. The information extractor extracts specific information regarding a user. The specific information is contained in contents of an utterance of the user. The extraction is made on a basis of the contents of the utterance of the user at a time of holding a dialog with any one agent out of a plurality of virtual agents. The judging unit judges which agent, out of the plurality of agents, use permission to use the extracted specific information is given to. The judgment is made on the basis of the specific information extracted by the information extractor, and adds a result of the judgment to the specific information as use permission information.

### TECHNICAL FIELD

The present disclosure relates to an information processing device that allows for a dialog with a user through a virtual agent, and to an information processing system.

### BACKGROUND ART

An information processing system has been developed that enables a robot or a virtual character created by software (hereinafter, collectively referred to as an “agent”) to take an action as if the agent talks to a user. The talking to the user is able to be achieved by using a medium such as speech synthesis or output texts on a screen of a display unit. In addition, a dialog system has been developed that enables an agent and a user to hold an interactive dialog (see Patent Literatures 1 and 2). For example, Patent Literature 1 proposes a dialog system that is able to hold a dialog including an operation such as searching as well as chatting. In addition, for example, Patent Literature 2 proposes a dialog system configured to be able to acquire information specific to a user (specific information regarding a user) through a dialog and record it.

### CITATION LIST

### Patent Literature

PTL 1: Japanese Unexamined Patent Application Publication No. 2014-98844 PTL 2: Japanese Unexamined Patent Application Publication No. 2017-62602

### SUMMARY OF THE INVENTION

In a case of the dialog system described above, for example, if a plurality of agents exists, details (specific information) of a dialog held by a user with a given one agent may spread and leak to other agents, which the user does not intend to.

It is desired to provide an information processing device configured to be able to prevent spread of specific information that a user does not intend, and also to provide an information processing system.

An information processing device according to an embodiment of the present disclosure includes an information extractor that extracts specific information regarding a user, the specific information being contained in contents of an utterance of the user, the extraction being made on a basis of the contents of the utterance of the user at a time of holding a dialog with any one agent out of a plurality of virtual agents, and also includes a judging unit that judges which agent, out of the plurality of agents, use permission to use the extracted specific information is given to, the judgment being made on a basis of the specific information extracted by the information extractor, and adds a result of the judgment to the specific information as use permission information.

An information processing system according to an embodiment of the present disclosure includes: an information server that is able to communicate to a plurality of virtual agents and provides specific information regarding a user to an agent, out of the plurality of agents, to which use permission is given; and at least one information processing device that looks up the specific information regarding the user provided by the information server to hold a dialog with the user through at least one agent out of the plurality of agents, in which information processing device includes: an information extractor that extracts the specific information regarding the user, the specific information being contained in contents of an utterance of the user, the extraction being made on a basis of the contents of the utterance of the user at a time of holding a dialog with the one agent out of the plurality of agents; a judging unit that judges which agent, out of the plurality of agents, use permission to use the extracted specific information is given to, the judgment being made on a basis of the specific information extracted by the information extractor, and adds a result of the judgment to the specific information as use permission information; and an outputting unit that outputs, to the information server, the specific information to which the use permission information is added by the judging unit.

In the information processing device or the information processing system according to the embodiment of the present disclosure, judgment is made as to which agent of a plurality of agents use permission to use the specific information is given to, on a basis of specific information contained in contents of an utterance of a user, and a result of the judgment is added to the specific information as use permission information.

### BRIEF DESCRIPTION OF THE DRAWINGS

FIG. 1 is a configuration diagram illustrating an outline of an information processing system according to a first embodiment of the present disclosure.

FIG. 2 is a block diagram illustrating an example of a configuration of an information processing device according to the first embodiment.

FIG. 3 is an explanatory view of an example of specific information to which use permission information is added.

FIG. 4 is an explanatory view of an example of a disclosure setting table.

FIG. 5 is an explanatory view of an example of an agent relationship table.

FIG. 6 is a flow diagram schematically illustrating one example of operation of the information processing device according to the first embodiment at a time of holding a dialog.

FIG. 7 is a block diagram illustrating an example of a configuration of an information processing device according to a second embodiment.

### MODES FOR CARRYING OUT THE INVENTION

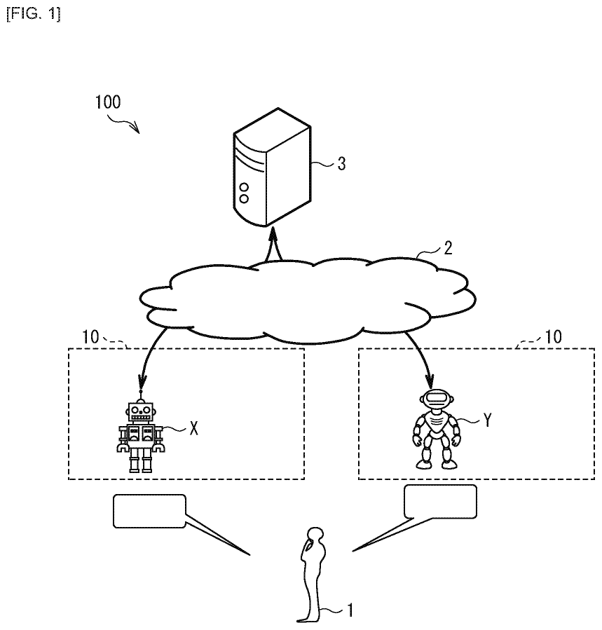

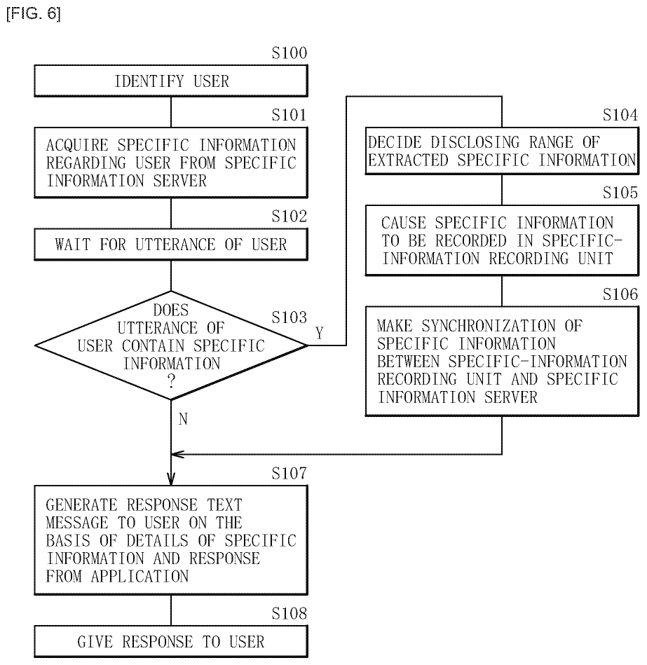

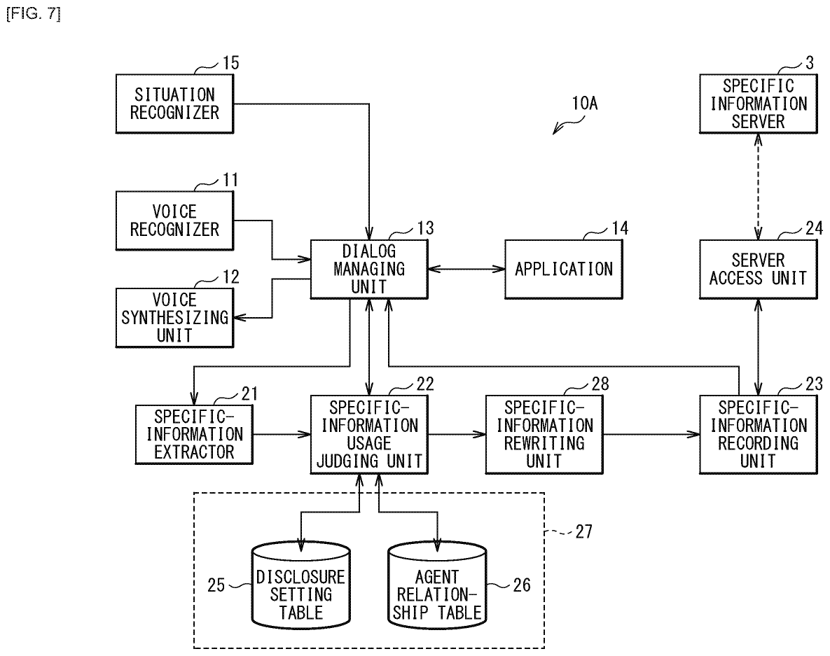

Below, embodiments according to the present disclosure will be described in detail with reference to the drawings. Note that description will be given in the following order.
0. Comparative Example
1. First Embodiment
1.1 Outline of Information Processing System (FIG. 1)
1.2 Example of Configuration of Information Processing Device (FIGS. 2 to 5)
1.3 Operation (FIG. 6)
1.4 Effect
2. Second Embodiment (FIG. 7)
3. Other Embodiment
<0. Comparative Example>
   (Outline of Information Processing System according to Comparative Example)

In an information processing system that allows for an interactive dialog between an agent and a user, it is possible to acquire that specific information regarding the user through the dialog, and to record the specific information for use on the agent side during subsequent dialogs.

For example, a certain agent A acquires specific information regarding a specific user through a dialog with this specific user. The specific information is recorded in a recording device that another agent B is able to use. This leads to an expectation that it is possible to give the specific user an improved level of satisfaction. For example, in a case where the agent A acquires, through a dialog with a specific user, specific information that favorite food of the specific user is cake, it is possible for the agent B to preferentially choose a topic of cake during a dialog with this specific user.

### (Problem)

By sharing specific information such as favorite food with a plurality of agents, it is possible to expect an improvement in the level of user satisfaction as described above. Here, let us consider, for example, a case in which a specific user talks to an agent A about specific information such as an action history of the specific user (for example, coming home late yesterday) or personal information of the specific user regarding likes and dislikes of a person (for example, falling in love with someone), and then, the agent A makes all the specific information available to an agent B. At this time, in a case where, during a dialog with the specific user, the agent B employs the specific information regarding the specific user acquired through the agent A, the specific user may have an impression of “Why did the agent B know what I talked only to the agent A? The agent A is a ‘blabbermouth’” or the like, which may make the specific user uncomfortable with that.

Thus, for an information processing system that enables an agent and a user to hold an interactive dialog, it is desired to develop a technology that is able to prevent spread of specific information that the user does not intend.

### 1. First Embodiment

### [1.1 Outline of Information Processing System]

FIG. 1 illustrates an outline of an information processing system 100 according to a first embodiment.

The information processing system 100 includes a specific information server 3, and at least one information processing device 10. The specific information server 3 and the information processing device 10 are coupled to a network 2.

The network 2 may be a WAN (wide area network) such as the Internet, or may be a LAN (local area network).

The information processing device 10 has a function of providing a user 1 with a virtual agent. In the information processing system 100, at least one information processing device 10 provides a plurality of agents. Alternatively, a plurality of information processing devices 10 may be provided. It may be possible to employ a mode in which one information processing device 10 provides one agent, or a mode in which one information processing device 10 provides a plurality of agents. The external appearance of an agent that makes the user 1 recognize may be the entire information processing device 10 (the entire housing), or may be a portion of the information processing device 10 (a portion of the housing). In this case, as illustrated in FIG. 2 that will be described later, the information processing device 10 includes a voice recognizer 11 and a voice outputting unit (voice synthesizing unit 12), which allows for a dialog with the user 1. In addition, it may be possible to employ a mode in which the information processing device 10 includes a display, and a virtual character is displayed on this display to cause the user 1 to visually recognize it as an agent. Furthermore, the function of holding a dialog by an agent is not limited to a dialog using voice. The dialog may be held with text information through the display.

The specific information server 3 is configured to be able to communicate to the plurality of agents (information processing device 10) through the network 2. The specific information server 3 has a function of recording specific information regarding the user 1 and providing the plurality of agents with the specific information regarding the user 1.

It should be noted that only one user 1 is illustrated in FIG. 1. However, a plurality of users may exist. In addition, two agents of an agent X and an agent Y are illustrated in FIG. 1 as an example. However, three or more agents may exist. Furthermore, each of the agents may be a dedicated agent that only one user 1 is able to use, or may be a agent that is shared with a plurality of users.

In this information processing system 100, for example, the agent X looks up specific information regarding the user 1 recorded in the specific information server 3 to hold a dialog with the user 1. Then, the agent X causes new specific information regarding the user 1 acquired through the dialog to be recorded in the specific information server 3.

Furthermore, the agent Y is also able to acquire specific information regarding the user 1 from the specific information server 3. At that time, it is possible to retrieve, from the specific information server 3, the specific information regarding the user 1 acquired by the agent X. Then, the agent Y holds a dialog with the user 1, and causes new specific information regarding the user 1 acquired as a result of this dialog to be added to and be recorded in the specific information server 3.

As described above, the information processing system 100 is configured to be able to share specific information regarding the same user 1 with a plurality of agents.

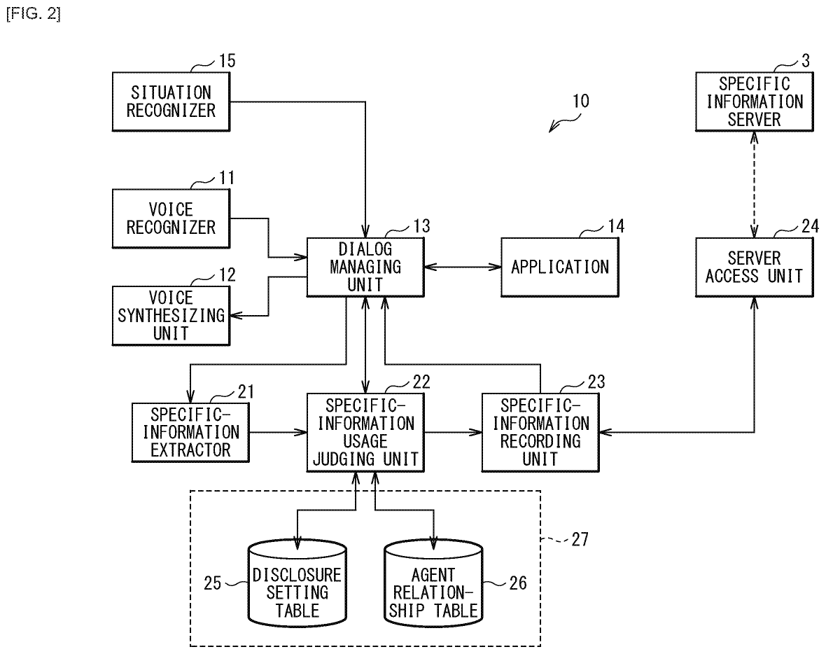

In a case of the present embodiment, the specific information server 3 provides specific information regarding the user 1 only to an agent, out of the plurality of agents, to which use permission is given. In this information processing system 100, the agent (for example, the agent X) that acquires the specific information through the dialog with the user 1 adds use permission information (“use permission” column in FIG. 3 that will be described later) regarding an “agent (for example, the agent Y) that is able to use the acquired specific information” to the specific information, and uploads the specific information to the specific information server 3. The specific information server 3 provides the specific information only to an agent to which the use permission is given.

### [1.2 Example of Configuration of Information Processing Device]

FIG. 2 illustrates an example of a configuration of the information processing device 10. FIG. 2 illustrates an example of a configuration in which a dialog between the user 1 and an agent is held through voice.

The information processing device 10 includes the voice recognizer 11, the voice synthesizing unit 12, a dialog managing unit 13, an application 14, and a situation recognizer 15. In addition, the information processing device 10 includes a specific-information extractor 21, a specific-information usage judging unit 22, a specific-information recording unit 23, a server access unit 24, and a database 27.

The dialog managing unit 13 corresponds to one specific example of a “dialog unit” in the technology according to the present disclosure. The specific-information extractor 21 corresponds to one specific example of an “information extractor” in the technology according to the present disclosure. The specific-information usage judging unit 22 corresponds to one specific example of a “judging unit” in the technology according to the present disclosure. The server access unit 24 corresponds to one specific example of an “outputting unit” in the technology according to the present disclosure.

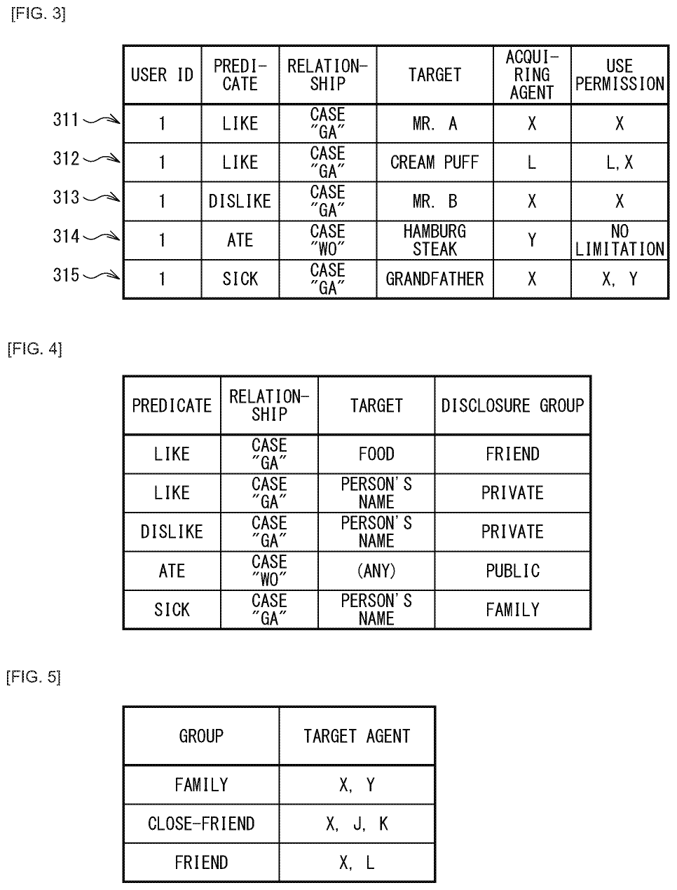

The database 27 includes a disclosure setting table 25 as illustrated in FIG. 4 that will be described later, and an agent relationship table 26 as illustrated in FIG. 5 that will be described later.

The information processing device 10 includes a CPU (central processing unit), which is not illustrated, and a program storing unit that store a program. Functions of the dialog managing unit 13, the application 14, the specific-information extractor 21, and the specific-information usage judging unit 22 are achieved, for example, with the CPU executing programs stored in the program storing unit.

The voice recognizer 11 includes a microphone that converts sounds into electrical signals. The voice synthesizing unit 12 includes a speaker serving as a voice outputting unit that converts electrical signals into sounds.

The situation recognizer 15 recognizes a situation of the user 1 at a time of holding a dialog. The situation recognizer 15 includes, for example, a camera or microphone, and recognizes, as a situation of the user 1, the prosody (intonation or the like) of an utterance of a user or facial expression when the user 1 gives the utterance.

The voice recognizer 11, the voice synthesizing unit 12, and the situation recognizer 15 are electrically coupled to the dialog managing unit 13.

The dialog managing unit 13 recognizes a voice of the user 1 through the voice recognizer 11, and performs natural language processing. The dialog managing unit 13 generates a response text message on the basis of a result of the natural language processing to output it to the user 1 through the voice synthesizing unit 12. The dialog managing unit 13 accesses the application 14 at the time of generating the response text message.

Contents of an utterance of a user are supplied to the specific-information extractor 21 through the dialog managing unit 13. On the basis of contents of an utterance of the user 1 at the time of holding a dialog with a given agent, the specific-information extractor 21 extracts specific information regarding the user contained in the contents of the utterance. The specific information extracted by the specific-information extractor 21 is supplied to the specific-information usage judging unit 22.

On the basis of the specific information extracted by the specific-information extractor 21, the specific-information usage judging unit 22 judges which agent, out of a plurality of agents, the use permission to use the extracted specific information is given to, and adds a result of the judgment to the specific information as the use permission information. At this time, the specific-information usage judging unit 22 adds the use permission information to the specific information on the basis of the disclosure setting table 25 and the agent relationship table 26. The specific-information usage judging unit 22 causes the specific information to which the use permission information is added, to be recorded in the specific-information recording unit 23.

The specific-information recording unit 23 records the specific information to which the use permission information is added by the specific-information usage judging unit 22. In addition, the specific information to which the use permission information is added by the specific-information usage judging unit 22 is outputted through the server access unit 24 to the specific information server 3, and is recorded in the specific information server 3. This allows for synchronization of the specific information recorded in the specific-information recording unit 23 and the specific information recorded in the specific information server 3.

The extraction of information from contents of an utterance of a user is achieved, for example, through Japanese Dependency and Case Structure Analyzer KNP disclosed by Kurohashi and Murawaki Laboratory in Kyoto University, which is described in detail in “Flow and Feature of Analysis in Syntactic and Predicate Argument Structure Analysis System KNP” in Proceedings of the 19th Annual Meeting of The Association for Natural Language Processing, March 2013.”

In such an analysis system, for example, in a case of contents of an utterance “ A-san ga suki (I like Mr. A)” by a user, a portion “like” and a portion “Mr. A” are coupled to each other using the grammatical case “ga.” Thus, it is possible to make analysis such that the target of “like” is “Mr. A.”

### (Specific Example of Specific Information)

The dialog managing unit 13 acquires user specific information from the specific-information recording unit 23, and is able to use it for the dialog output.

FIG. 3 illustrates an example of specific information that is recorded in the specific-information recording unit 23 and to which use permission information is added. FIG. 4 illustrates an example of the disclosure setting table 25 that is looked up when the use permission information is added. FIG. 5 illustrates an example of the agent relationship table 26 that is looked up when the use permission information is added.

The specific information recorded in the specific-information recording unit 23 includes, for example, “predicate,” “relationship,” and “target,” each of which is extracted from the utterance of the user 1, and also includes ID of an agent that acquires the information. In addition, the specific information includes a user ID that indicates which user the specific information relates to.

The specific-information extractor 21 extracts specific information from contents of an utterance of a user. At this point in time, it is possible to acquire information (that is, user ID, predicate, relationship, target, and acquiring agent) regarding data row excluding “use permission” in FIG. 3. After this, on the basis of the disclosure setting table 25 (FIG. 4) and the agent relationship table 26 (FIG. 5), the specific-information usage judging unit 22 writes, in a column of use permission of the specific information, the ID of an agent to which use permission serving as use permission information is given. Then, the specific information is recorded in the specific-information recording unit 23, and is used in a dialog. In addition, the specific information is also recorded in the specific information server 3. This allows for synchronization of the specific information between the specific-information recording unit 23 and the specific information server 3. The specific information server 3 provides information only to an agent to which the use permission is given.

For example, in a case where the agent X hears from the user 1 that the user 1 likes Mr. A and dislikes Mr. B, only the agent X is able to use this specific information in the case of the example in FIG. 3. In addition, for example, in a case where the agent Y hears from the user 1 that the user 1 ate hamburg steak, all the agents are able to use this specific information in the case of the example in FIG. 3.

Depending on contents of an utterance of a user, the dialog managing unit 13 is able to respond with chat reply if it does not relate to an operation of a specific task. The specific task is, for example, a response regarding a searched result in a case where contents of an utterance of a user simply relate to a request for searching for something. In addition, for example, at a timing in which the utterance of a user interrupts for a certain period of time, the agent may voluntarily perform chat reply regardless of details of the utterance of the user 1.

The specific-information usage judging unit 22 decides an agent that is able to use the specific information on the basis of details of the extracted specific information. For example, in a case where the “predicate” relates to likes and dislikes and the “target” relates to a name of a person, permission to use the information is given only to the agent that acquires the information.

Judgment of “use permission” by the specific-information usage judging unit 22 may be made not only on the basis of details of the extracted specific information but also on the basis of relationship information regarding an agent. This includes, for example, a case in which the user 1 gives the agent Y special permission to look up all the knowledge of the agent X, and a case in which it is set that the user 1 has already recognized that the agent X and the agent Y “particularly have a close relationship with each other” or the like.

In the following description, the specific information in FIG. 3 will be described in more detail. FIG. 3 particularly illustrates an example of the specific information regarding the user 1 acquired by the agent X.

The specific-information usage judging unit 22 looks up a relationship table indicating a relationship between a plurality of agents to divide the plurality of agents into a plurality of groups in terms of sameness of relationship. Then, the specific-information usage judging unit 22 judges, for each of the groups, whether or not to give permission to use the extracted specific information. The relationship table as used here is, for example, the agent relationship table 26 illustrated in FIG. 5.

Specific information 311 in FIG. 3 indicates an example of information in which the user 1 talks to the agent X that “I like Mr. A.” As indicated in the disclosure setting table 25 (FIG. 4), the information “like (person's name)” belongs to a disclosure group of “private.” Thus, the specific-information usage judging unit 22 writes a value of “X” indicating an agent that acquires the information, in a column of use permission in the specific information 311. With this operation, only the agent X, which is the agent that acquires the information, is given permission to use the specific information 311, and the specific information 311 is not disclosed to agents other than the agent X.

Specific information 312 indicates an example of information in which the user 1 talks to an agent L that “I like cream puffs.” As indicated in the disclosure setting table 25 (FIG. 4), the information “like (food)” belongs to a disclosure group of “friend.” In addition, as indicated in the agent relationship table 26 (FIG. 5), the agents X and L are in a relationship of “friend.” Thus, the specific-information usage judging unit 22 writes values “X” and “L” in a column of use permission in the specific information 312. The agents L and X are given permission to use the specific information 312, and thus, the specific information 312 is information that the agent X is able to acquire from the specific information server 3.

Specific information 313 indicates an example of information in which the user 1 talks to the agent X that “I dislike Mr. B.” As indicated in the disclosure setting table 25 (FIG. 4), the information “dislike (person's name)” belongs to a disclosure group of “private.” Thus, the specific-information usage judging unit 22 writes a value “X” indicating the information acquiring agent in a column of use permission in the specific information 313. With this operation, only the agent X, which is the agent that acquires the information, is given permission to use the specific information 313, and the specific information 313 is not disclosed to agents other than the agent X.

Specific information 314 indicates an example of information in which the user 1 talks to the agent Y that “I ate hamburg steak.” As indicated in the disclosure setting table 25 (FIG. 4), the information “ate something” belongs to a disclosure group of “pulic.” Thus, the specific-information usage judging unit 22 writes “no limitation” in a column of use permission in the specific information 314.

Specific information 315 indicates an example of information in which the user 1 talks to the agent X that “my grandfather gets sick.” As indicated in the disclosure setting table 25 (FIG. 4), the information “(person's name) get sick” belongs to a disclosure group of “family.” In addition, as indicated in the agent relationship table 26 (FIG. 5), the agents X and Y are in relationship of “family.” Thus, the specific-information usage judging unit 22 writes values “X” and “Y” in a column of use permission in the specific information 312. This results in permission to use the specific information 315 being also given to the agent Y although the specific information 315 is information told to the agent X.

As illustrated in FIG. 4, the disclosure setting table 25 relates to, for example, relationships between disclosure groups and information corresponding to three data rows (predicate, relationship, and target) in the specific information in FIG. 3. However, rather than a specific name of a target item, a category may be written. For example, it is possible to write “food” as one example of information concerning “target.” In addition, it is possible to write an item such as “(any)” that does not apply any condition.

In addition to the groups such as “family,” “close-friend,” or “friend” written in the agent relationship table 26 in FIG. 5 as disclosure groups, it is possible to write “private (not disclosed),” “public (no limitation),” or the like in the disclosure setting table 25. Note that, in a case of “private,” the use permission is given only to the agent that acquires the specific information.

It should be noted that, in the example in FIG. 4, the “predicate,” the “relationship,” and the “target” are written in a form of table. However, the specific-information usage judging unit 22 is able to use machine learning or the like to judge the similarity of specific information relative to portions of “predicate” or “target” in the disclosure setting table 25. For example, in a case where “steamed pork bun” is listed in a column of “target” in the disclosure setting table 25 and the specific information is a “bun,” it may be possible to perform processing in which the specific information is considered to match in terms of the “target” in the disclosure setting table 25.

As illustrated in FIG. 5, the agent relationship table 26 contains correspondence relationship between “name of group” and “target agent” corresponding to the group. FIG. 5 gives an example in which “family,” “close-friend,” and “friend” are written as the name of group. However, the name of group written in the agent relationship table 26 is not limited to these names.

In addition, the target agent is not necessarily an agent that an actual family owns or an agent that a friend owns. For example, a relationship in which “the agent X and the agent Y have a close relationship with each other” is given as a part of characterization of an agent. Similarly, even in a case where a user that owns the agent X and a user that owns the agent Y are in a relationship of family, it may be possible to reflect characterization between agents, such as “the agent X and the agent Y don't get along,” and to apply control such that they are not written as the group of “family” on purpose.

### (Modification Example)

In addition to the example in FIG. 3, for example, situations of the user 1 at the time of acquiring information may be taken into consideration for specific information. The situation recognizer 15 may recognize situations of the user 1 at the time of extracting the specific information, and output a result of the recognition as situation recognition information to the specific-information usage judging unit 22 through the dialog managing unit 13. On the basis of the situation recognition information recognized by the situation recognizer 15 and the specific information extracted by the specific-information extractor 21, the specific-information usage judging unit 22 may judge which agent, out of the plurality of agents, the permission to use the extracted specific information is given to.

The situation recognition information acquired by the situation recognizer 15 may include, for example, the following information.
Speaking very quietly (prosody of voice)
Told that “It's a secret,” “Can you keep it secret?”(explicit instruction from a user)
Told with serious face (result of facial expression recognition)

It may be possible to record the situation recognition information as described above to extend the setting such that the disclosure setting for each of the situation recognition information is reflected in the disclosure setting table 25. For example, in a case where there is recognition information of “I was told that ‘someone got sick’ with ‘serious face’,” it may be possible to extend the setting such that the disclosure group is set to “private” rather than “family.”

Furthermore, in a case where an agent other than the agent that directly acquires specific information uses this specific information during chatting, it is possible to provide the source of the specific information by saying “I heard from the agent X but do you like cream puff?” This makes it possible to increase transparency of information communication between agents from the viewpoint of the user 1.

### [1.3 Operation]

FIG. 6 illustrates an example of operation by an agent (information processing device 10) at the time of dialog.

First, the dialog managing unit 13 identifies the user 1 (step S100). Next, the information processing device 10 acquires specific information regarding the user 1 from the specific information server 3 through the server access unit 24 (step S101). The acquired specific information is recorded in the specific-information recording unit 23. This makes it possible for the dialog managing unit 13 to look up the specific information regarding the user 1 recorded in the specific-information recording unit 23 to hold a dialog with the user 1. Next, the dialog managing unit 13 waits for an utterance of the user 1 (step S102).

Next, the specific-information extractor 21 judges whether or not the utterance of the user 1 contains the specific information (step S103). In a case where the specific-information extractor 21 judges that the utterance of the user 1 does not contain the specific information (step S103; N), then the dialog managing unit 13 generates a response text message to the user 1 on the basis of details of the specific information recorded in the specific-information recording unit 23 and the response from the application 14 (step S107). Next, the dialog managing unit 13 outputs the generated response text message through the voice synthesizing unit 12 to give response to the user 1 (step S108).

Meanwhile, in a case where the specific-information extractor 21 judges that the utterance of the user 1 contains the specific information (step S103; Y), then the specific-information usage judging unit 22 decides a disclosing range of the extracted specific information (range of agents to which use permission is given) (step S104). Next, the specific-information usage judging unit 22 causes the specific information to which the use permission information is added, to be recorded in the specific-information recording unit 23 (step S105). Then, the specific-information usage judging unit 22 makes synchronization of the specific information between the specific-information recording unit 23 and the specific information server 3 through the server access unit 24 (step S106). After this, the dialog managing unit 13 moves to the process of step S107.

### [1.4 Effect]

As described above, according to the present embodiment, use permission information is added to specific information on the basis of the specific information contained in the contents of an utterance of the user 1. This makes it possible to prevent the specific information from spreading in a manner in which the user 1 does not intend. Thus, it is possible to prevent information from spreading to another agent (for example, agent Y) that the user 1 does not intend while utilizing details that the user 1 talks to one given agent (for example, agent X) for chatting with the agent X. In addition, it is possible to increase friendliness from the user 1 toward the agent X.

It should be noted that the effects described in the present description are merely examples, and are not given for the purpose of limitation. In addition, other effects may be taken. The same applies to effects of other embodiments below.

### 2. Second Embodiment

Next, an information processing device and an information processing system according to a second embodiment of the present disclosure will be described. Note that, in the following description, the same reference characters are assigned to portions that are substantially the same as the constituent elements of the information processing device and the information processing system according to the first embodiment described above, and explanation thereof will not be repeated as appropriate.

FIG. 7 illustrates an example of a configuration of an information processing device 10A according to the second embodiment of the present disclosure.

As illustrated in FIG. 7, a specific-information rewriting unit 28 that rewrites specific information may be additionally provided between the specific-information usage judging unit 22 and the specific-information recording unit 23. The specific-information rewriting unit 28 modifies the specific information extracted by the specific-information extractor 21, for example, on the basis of a character setting of an agent which a dialog is held with.

The specific-information rewriting unit 28 is able to change (modify) the specific information that the agent acquires to express a character setting of the agent or a relationship of the agent. For example, in a case where the user 1 gave the agent X certain information that “cream puff” “is” “a favorite of mine,” the “cream puff” may be replaced with “sweets” in the specific-information rewriting unit 28. This makes it possible to show a character of the agent X being careless. In addition, for example, by replacing the “cream puff” with “ice cream” in the specific-information rewriting unit 28, it is possible to show that the agent X is “sloppy.” Furthermore, by giving information such as a time that certain information is acquired or a facial expression of the user 1 in a very detailed manner, it is possible to show that the agent X has a “detail-focused personality.”

The other configuration, operation, and effects may be substantially similar to those of the information processing device 10 and the information processing system 100 according to the first embodiment described above.

### 3. Other Configurations

The technology according to the present disclosure is not limited to that described in each of the embodiments described above, and it is possible to make various changes.

For example, in the embodiments described above, specific information is provided only to an agent having use permission at a stage in which the specific information is provided from the specific information server 3. However, the specific information may be provided from the specific information server 3 to all the agents regardless of use permission. In addition, judgment as to whether or not an agent is able to actually use the specific information is made by the agent itself on the information processing device side, on the basis of the use permission information added to the specific information. For example, when the dialog managing unit 13 looks up specific information recorded in the specific-information recording unit 23 to hold a dialog with the user 1, judgment as to whether or not specific information that is able to be used may be made on the basis of the use permission information added to the specific information.

Furthermore, for example, each of the constituent elements in each of the embodiments described above may be divided into a plurality of pieces, and the plurality of divided constituent elements may function differently.

Furthermore, for example, in operation flows in each of the embodiments described above, an operation flow may be performed such that a portion of each processing step is omitted. In addition, an operation flow may be performed such that another processing step that is not described in the operation flow is added. Moreover, it may be possible to perform an operation flow in which the order of implementation of individual processing steps in the operation flow is partially changed.

For example, the present technology may take the following configurations. According to the present technology having the following configurations, on the basis of specific information contained in contents of an utterance of a user, use permission information is added to the specific information. This makes it possible to prevent the specific information from spreading, which the user does not intend.

(1) An information processing device including:

an information extractor that extracts specific information regarding a user, the specific information being contained in contents of an utterance of the user, the extraction being made on a basis of the contents of the utterance of the user at a time of holding a dialog with any one agent out of a plurality of virtual agents, and

a judging unit that judges which agent, out of the plurality of agents, use permission to use the extracted specific information is given to, the judgment being made on a basis of the specific information extracted by the information extractor, and adds a result of the judgment to the specific information as use permission information.

(2) The information processing device according to (1) described above, further including

a specific-information recording unit that records the specific information to which the use permission information is added by the judging unit.

(3) The information processing device according to (1) or (2) described above, further including

a specific-information rewriting unit that modifies the extracted specific information on a basis of a character setting of the agent that holds the dialog.

(4) The information processing device according to any one of (1) to (3) described above, further including

an outputting unit that outputs the specific information to which the use permission information is added by the judging unit, to an information server to which each of the plurality of agents is able to communicate.

(5) The information processing device according to (4) described above, in which the information server provides the specific information regarding the user only to the agent, out of the plurality of agents, to which the use permission is given.

(6) The information processing device according to (5) described above, further including

a dialog unit that looks up the specific information regarding the user provided by the information server to hold a dialog with the user.

(7) The information processing device according to any one of (1) to (6) described above, in which

the judging unit looks up a relationship table indicating a relationship between the plurality of agents to divide the plurality of agents into a plurality of groups in terms of sameness of relationship, and judges, for each of the groups, whether or not to give the use permission to use the extracted specific information.

(8) The information processing device according to any one of (1) to (7) described above, further including

a situation recognizer that recognizes a situation of the user when the specific information is extracted, and outputs a result of the recognition as situation recognition information, in which

the judging unit judges which agent, out of the plurality of agents, the use permission to use the extracted specific information is given to, on a basis of the situation recognition information recognized by the situation recognizer and the specific information extracted by the information extractor.

(9) The information processing device according to (8) described above, in which the situation recognizer recognizes prosody of an utterance of the user as the situation of the user.

(10) The information processing device according to (8) described above, in which the situation recognizer recognizes, as the situation of the user, a facial expression when the user gives an utterance.

(11) An information processing system including:

an information server that is configured to communicate to a plurality of virtual agents and provides specific information regarding a user to an agent, out of the plurality of agents, to which use permission is given; and

at least one information processing device that looks up the specific information regarding the user provided by the information server to hold a dialog with the user through at least one agent out of the plurality of agents, in which

the information processing device includes:

an information extractor that extracts the specific information regarding the user, the specific information being contained in contents of an utterance of the user, the extraction being made on a basis of the contents of the utterance of the user at a time of holding a dialog with the one agent out of the plurality of agents;

a judging unit that judges which agent, out of the plurality of agents, use permission to use the extracted specific information is given to, the judgment being made on a basis of the specific information extracted by the information extractor, and adds a result of the judgment to the specific information as use permission information; and

an outputting unit that outputs, to the information server, the specific information to which the use permission information is added by the judging unit.

(12) The information processing system according to (11) described above, in which

the information processing device further includes a specific-information recording unit that records the specific information regarding the user provided by the information server, and also records the specific information to which the use permission information is added by the judging unit.

The present application claims priority based on Japanese Patent Application No. 2018-052264 filed with the Japan Patent Office on Mar. 20, 2018, the entire contents of which are incorporated herein by reference.

It should be understood that those skilled in the art would make various corrections, combinations, sub-combinations, and changes depending on design requirements and other factors, and they are within the scope of the attached claims or the equivalents thereof.

1. An information processing device comprising:
an information extractor that extracts specific information regarding a user, the specific information being contained in contents of an utterance of the user, the extraction being made on a basis of the contents of the utterance of the user at a time of holding a dialog with any one agent out of a plurality of virtual agents, and
a judging unit that judges which agent, out of the plurality of agents, use permission to use the extracted specific information is given to, the judgment being made on a basis of the specific information extracted by the information extractor, and adds a result of the judgment to the specific information as use permission information.

2. The information processing device according to claim 1, further comprising
a specific-information recording unit that records the specific information to which the use permission information is added by the judging unit.

3. The information processing device according to claim 1, further comprising
a specific-information rewriting unit that modifies the extracted specific information on a basis of a character setting of the agent that holds the dialog.

4. The information processing device according to claim 1, further comprising
an outputting unit that outputs the specific information to which the use permission information is added by the judging unit, to an information server to which each of the plurality of agents is able to communicate.

5. The information processing device according to claim 4, wherein the information server provides the specific information regarding the user only to the agent, out of the plurality of agents, to which the use permission is given.

6. The information processing device according to claim 5, further comprising
a dialog unit that looks up the specific information regarding the user provided by the information server to hold a dialog with the user.

7. The information processing device according to claim 1, wherein the judging unit looks up a relationship table indicating a relationship between the plurality of agents to divide the plurality of agents into a plurality of groups in terms of sameness of relationship, and judges, for each of the groups, whether or not to give the use permission to use the extracted specific information.

8. The information processing device according to claim 1, further comprising
a situation recognizer that recognizes a situation of the user when the specific information is extracted, and outputs a result of the recognition as situation recognition information, wherein
the judging unit judges which agent, out of the plurality of agents, the use permission to use the extracted specific information is given to, on a basis of the situation recognition information recognized by the situation recognizer and the specific information extracted by the information extractor.

9. The information processing device according to claim 8, wherein the situation recognizer recognizes prosody of an utterance of the user as the situation of the user.

10. The information processing device according to claim 8, wherein the situation recognizer recognizes, as the situation of the user, a facial expression when the user gives an utterance.

11. An information processing system comprising:
an information server that is configured to communicate to a plurality of virtual agents and provides specific information regarding a user to an agent, out of the plurality of agents, to which use permission is given; and
at least one information processing device that looks up the specific information regarding the user provided by the information server to hold a dialog with the user through at least one agent out of the plurality of agents, wherein
the information processing device includes:
an information extractor that extracts the specific information regarding the user, the specific information being contained in contents of an utterance of the user, the extraction being made on a basis of the contents of the utterance of the user at a time of holding a dialog with the one agent out of the plurality of agents;
a judging unit that judges which agent, out of the plurality of agents, use permission to use the extracted specific information is given to, the judgment being made on a basis of the specific information extracted by the information extractor, and adds a result of the judgment to the specific information as use permission information; and
an outputting unit that outputs, to the information server, the specific information to which the use permission information is added by the judging unit.

12. The information processing system according to claim 11, wherein
the information processing device further includes a specific-information recording unit that records the specific information regarding the user provided by the information server, and also records the specific information to which the use permission information is added by the judging unit.
